(19) United States
(12) Patent Application Publication
(10) Pub. No.: US 2023/0296726 A1
(43) Pub. Date: Sep. 21, 2023

(54) VEHICLE SPEED MODULE FOR RADAR SPEED DETECTOR

(71) Applicant: Applied Concepts, Inc., Richardson, TX (US)

(72) Inventors: Devin L. Kautz, Melissa, TX (US); Alan Mead, Allen, TX (US); Stanley A. Walker, Flower Mound, TX (US); John Miller, Lewisville, TX (US)

(73) Assignee: Applied Concepts, Inc., Richardson, TX (US)

(21) Appl. No.: 18/123,057

(22) Filed: Mar. 17, 2023

Related U.S. Application Data
(60) Provisional application No. 63/320,949, filed on Mar. 17, 2022.

(51) Int. Cl. G01S 7/40; G01S 13/60

(52) U.S. Cl. CPC G01S 7/40; G01S 13/60

(57) ABSTRACT

A method for calibrating a patrol vehicle speed, comprising initiating a calibration cycle at a speed detection radar unit mounted in a vehicle, operating the vehicle to generate a vehicle speed signal using the speed detection radar unit and exiting the calibration cycle if the vehicle speed signal matches an observed speed from an independent source signal.

### RELATED APPLICATIONS

This application claims benefit of and priority to U.S. Provisional patent application 63/320,949, which was filed on Mar. 17, 2022 and which is hereby incorporated by reference for all purposes as if set forth herein in its entirety.

### TECHNICAL FIELD

The present disclosure relates generally to vehicle speed detection, and more specifically to a vehicle speed module for radar speed detection.

### BACKGROUND OF THE INVENTION

Detecting a vehicle speed is known, but combining that with other systems is not.

### SUMMARY OF THE INVENTION

A method for calibrating a patrol vehicle speed is disclosed that includes initiating a calibration cycle at a speed detection radar unit mounted in a vehicle, such as by manually pushing a button, automatically detecting a calibration period or in other suitable manners. The vehicle is then operated to generate a vehicle speed signal using the speed detection radar unit, such as by driving the vehicle in a manner that generates accelerometer data changes. The calibration cycle is exited if the vehicle speed signal matches an observed speed from an independent source signal, such as when a user observes that the match has occurred.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE SEVERAL VIEWS OF THE DRAWINGS

Aspects of the disclosure can be better understood with reference to the following drawings. The components in the drawings may be to scale, but emphasis is placed upon clearly illustrating the principles of the present disclosure. Moreover, in the drawings, like reference numerals designate corresponding parts throughout the several views, in which:

FIG. 1 is a diagram of a system for speed module calibration, in accordance with an example embodiment of the present disclosure;

FIG. 2 is a diagram of an algorithm for module calibration, in accordance with an example embodiment of the present disclosure;

FIG. 3 is a diagram of an algorithm for accelerated calibration, in accordance with an example embodiment of the present disclosure;

FIG. 4 is a diagram of an algorithm for patrol speed calibration, in accordance with an example embodiment of the present disclosure; and

FIG. 5 is a diagram of an algorithm for radar window adjustment, in accordance with an example embodiment of the present disclosure.

### DETAILED DESCRIPTION OF THE INVENTION

In the description that follows, like parts are marked throughout the specification and drawings with the same reference numerals. The drawing figures may be to scale and certain components can be shown in generalized or schematic form and identified by commercial designations in the interest of clarity and conciseness.

This application claims benefit of and priority to U.S. Provisional patent application 63/320,949, which was filed on Mar. 17, 2022 and which is hereby incorporated by reference for all purposes as if set forth herein in its entirety.

The radar speed module of the present disclosure can be installed on the back of an existing speed detection radar or in other manners. The module can use GPS and a built-in accelerometer to eliminate patrol car speed combining and shadowing in traffic, to allow patrol car speed tracking in tunnels and under bridges, to allow automatic switching between a moving mode and a stationary mode of operation, and for other suitable purposes.

The radar speed module can be configured with an internal GPS antenna, with an external GPS antenna connector or in other suitable manners. In one example embodiment, if the radar speed detector has a counting unit that is installed on the dashboard, that can indicate that the internal GPS antenna or that a GPS antenna with an attached cable is used. If the counting unit is mounted in a console or under the seat, that can indicate an external GPS antenna with an attached cable. The GPS antenna can be securely adhered to the dash and have a clear view of the sky.

To mount the radar speed module to the counting unit, the power cable can be removed, the speed module can be plugged into the counting unit and secured with machine screws, washers, lock washers or other suitable hardware. The screws can be lightly tightened, then turned an additional ½ turn to secure. The power cable can be connected to the rear of the radar speed module.

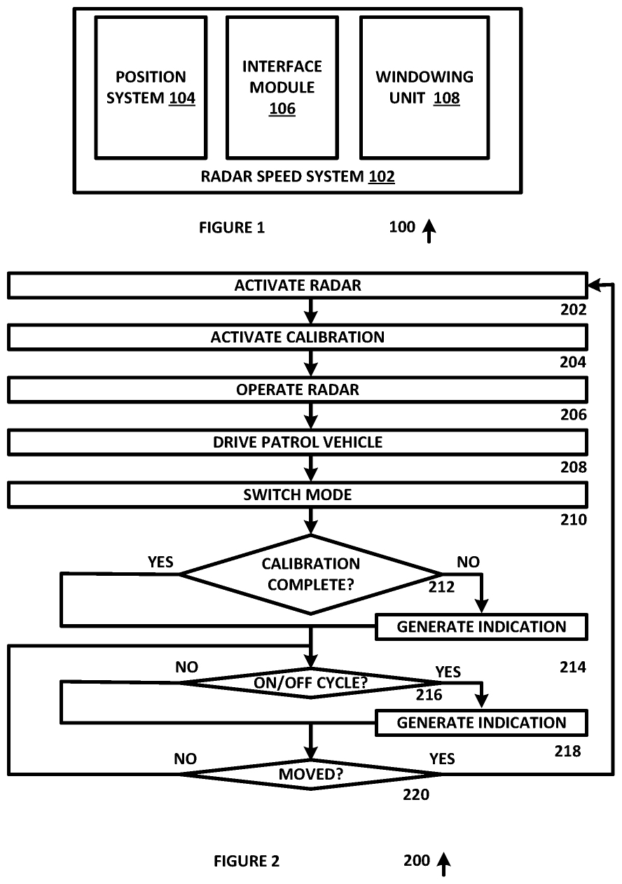

FIG. 1 is a diagram of a system 100 for speed module calibration, in accordance with an example embodiment of the present disclosure. System 100 includes radar speed system 102, position system 104, interface module 106 and windowing unit 108, each of which can be implemented in hardware or a suitable combination of hardware and software.

Radar speed system 102 can be a system that generates electromagnetic radiation and receives reflected signals from objects, such as that disclosed in U.S. Pat. No. 7,038,614, which is hereby incorporated by reference for all purposes as if set forth herein in its entirety. Radar speed system 102 can include a digital signal processor or other suitable processor that can process the reflected signals to generate speed data for the objects, as well as other processing to identify objects that are moving or stationary, objects that are approaching or receding, a patrol vehicle speed for a patrol vehicle that radar speed system 102 is mounted in, as well as other suitable functions as disclosed and discussed herein.

Position system 104 can be a global positioning system, a global navigation satellite system, or other suitable satellite or land-based navigation systems that provide autonomous geo-spatial positioning with local or global coverage. In one example embodiment, position system 104 can generate location data independent of any reflected signals.

Interface module 106 can be implemented as a digital signal processor or other suitable processors that can receive data from radar speed system 102, position system 104 or other suitable systems and can generate data in response for use by radar speed system 102, position system 104 or other suitable systems. In one example embodiment, interface module 106 can be implemented on a digital signal processor of radar speed system 102, position system 104 or other suitable systems. Interface module 104 can receive data from radar speed system 102, position system or other suitable systems, and can determine whether to generate control data for radar speed system 102, position system 104 or other suitable systems, as discussed further herein.

Windowing unit 108 can receive processed data and can generate windows for use in analyzing the speed of vehicles. In one example embodiment, windowing unit 108 can receive fast Fourier transform data and can generate one or more windows to improve processing of data by radar speed system 102, such as by shifting a window to use a frequency bin that represents a vehicle speed where the window is skewed, such as where a distance in bins from the low boundary to the vehicle speed bin is greater than the distance in bins from the vehicle speed to the high boundary. For example, if the vehicle speed bin is 13, then the window would be something like 5 bins lower and 2 bins higher, or bin 8 to bin 15, which would improve detection accuracy for vehicles that are likely to be speeding. Likewise, other suitable processes can also or alternatively be implemented.

FIG. 2 is a diagram of an algorithm 200 for module calibration, in accordance with an example embodiment of the present disclosure. Algorithm 200 can be implemented in hardware or a suitable combination of hardware and software.

For module calibration, the radar speed module can be calibrated for the vehicle and location. For initial calibration, power to the radar can be turned on and then the radar can sit for a suitable period, such as 5 minutes, with a clear view of the sky to allow the GPS to acquire the satellites. This procedure can be performed automatically in the background while on patrol but may take many minutes. Normally this procedure only needs to be performed once, after initial installation.

Algorithm 200 begins at 202, where the radar unit is turned on and allowed to sit for roughly 5 minutes with a clear view of the sky, to allow a satellite-based positioning system to acquire a signal from associated satellites. Likewise, other positioning systems that do not use a satellite signal can also or alternatively be used, such as systems that use land-based signals that are not reflected signals from a radar. The algorithm then proceeds to 204.

At 204, a user activates a calibrate button, such as one that is located on the back of the radar speed module. Alternatively the calibration process can be automatically initiated without user intervention, can be initiated in response to some other vehicular data signal, a prompt can be generated to alert a user that calibration has not been initiated, or other suitable processes can also or alternatively be used. The algorithm then proceeds to 206.

At 206, a radar unit can operate in a normal mode of operation. The algorithm then proceeds to 208.

At 208, a patrol vehicle can be driven to allow the radar speed detector to operate normally. A user can confirm that a speedometer-generated speed and a patrol speed generated by the radar unit match, the system can be configured to generate a prompt to confirm that the speeds match, or other suitable data can be processed to determine whether a match exists, such as image data from inside of the vehicle or other suitable vehicle data. The algorithm then proceeds to 210.

At 210, a key on a radar unit or remote controller can be activated by a user to switch between a moving mode and a stationary mode, a patrol speed blank key or other suitable controls to eliminate combining or shadowing. The algorithm then proceeds to 212.

At 212, it is determined whether vehicle calibration is complete. It may take a period of time of vehicle motion to complete calibration, but the radar is usable for enforcement or other purposes during this time. If a vehicle executes turns, those can shorten the calibration time by increasing the amount of data that is processed. The algorithm then proceeds to 214.

At 214, when the radar speed module is being calibrated, a user interface indication can be illuminated in a user interface window, to indicate that the radar is training to the radar speed module. When the radar is ready for use and can automatically switch between stationary and moving modes, the user interface indication can be turned off, a different user interface indication can be activated or other suitable processes can also or alternatively be used. The algorithm then proceeds to 216.

At 216, it is determined whether the radar has gone through an off/on power cycle, after which the radar speed module may need some time to acquire the external speed signal, such as from a satellite or other sources. If it is determined that a power cycle has occurred, the algorithm proceeds to 218, where a user notification is generated for a suitable period of time. The algorithm then proceeds to 220.

At 220, it is determined whether the radar unit has been moved or installed in another vehicle. If so, the algorithm repeats, otherwise the algorithm returns to 216.

In operation, algorithm 200 allows a radar unit to be calibrated without using a GPS signal as a patrol speed for detection of speeding vehicles. While algorithm 200 is shown as a flow chart, a person of skill in the art will recognize that object-oriented programming, state diagrams, ladder diagrams or other suitable programming paradigms can also or alternatively be used to implement algorithm 200.

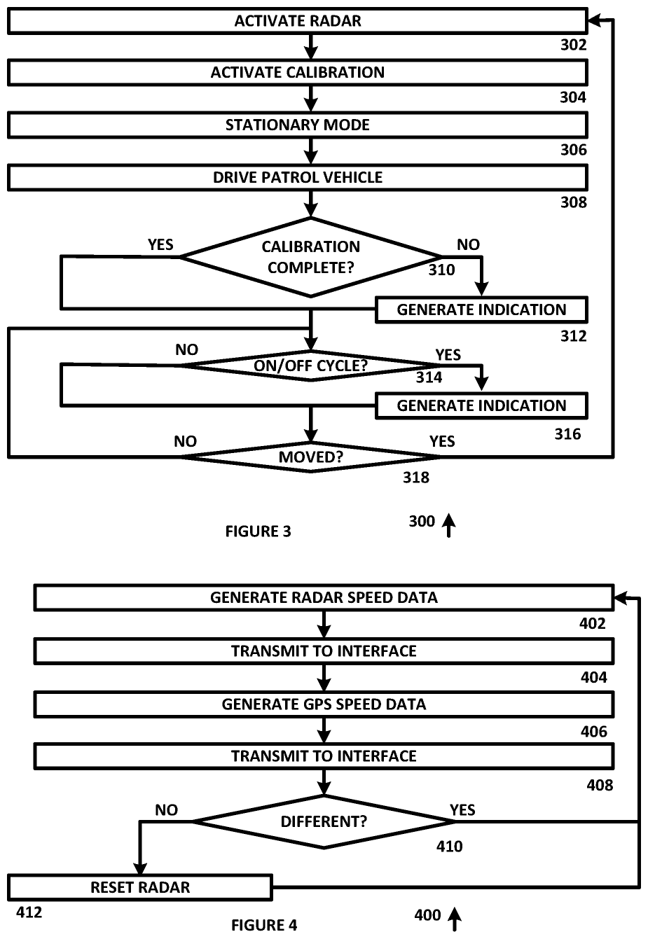

FIG. 3 is a diagram of an algorithm 300 for accelerated calibration, in accordance with an example embodiment of the present disclosure. Algorithm 300 can be implemented in hardware or a suitable combination of hardware and software.

Algorithm 300 begins at 302, where the radar is turned on and allowed to operate for a sufficient period of time with a clear view of the sky, to allow a satellite-based speed system to acquire the satellites or for other suitable purposes, such as to acquire land-based signals. The algorithm then proceeds to 304.

At 304, a calibration button can be activated, calibration mode can be automatically entered or other suitable processes can be implemented. The algorithm then proceeds to 306.

At 306, the radar can be switched to stationary mode. The algorithm then proceeds to 308.

At 308, the vehicle can be driven in a large open area, such as in a figure eight path or in other suitable manners, until the radar switches to moving mode, indicating completion of calibration. In one example embodiment, driving to generate a substantial g-force on the accelerometer can help to facilitate calibration. The algorithm then proceeds to 310.

At 310, when the radar speed module is being calibrated, an indication can be illuminated at 312 in the patrol window to indicate that the radar is training to the speed module. After training mode is completed, the indication can be stopped or changed, to indicate that the radar is ready for use and will automatically switch between stationary and moving modes. The algorithm then proceeds to 314.

At 314, whenever the radar goes through an off/on power cycle, an indication can be generated to the user at 316 that the radar speed module may need to acquire the GPS signal. The algorithm then proceeds to 318.

At 318, it is determined whether the above procedure needs to be repeated, such as if the radar is moved or installed in another vehicle. If so, the algorithm repeats, otherwise the algorithm returns to 314.

For daily use after the radar speed module is calibrated, daily start-up time may vary depending on how long the radar unit has been powered off. The unit might not immediately auto-switch to moving mode. A moving/stationary mode key can be used to switch between moving and stationary modes and the PS Blank key to correct any patrol speeds until the satellites are acquired.

In one example embodiment, a u-blox intelligent device with accelerometer and GPS receiver available from https://www.u-blox.com/en of Switzerland or other suitable devices can be used in combination with the disclosed embodiments and processes.

In operation, algorithm 300 allows a radar unit to be calibrated without using a GPS signal as a patrol speed for detection of speeding vehicles. While algorithm 300 is shown as a flow chart, a person of skill in the art will recognize that object-oriented programming, state diagrams, ladder diagrams or other suitable programming paradigms can also or alternatively be used to implement algorithm 300.

FIG. 4 is a diagram of an algorithm 400 for patrol speed calibration, in accordance with an example embodiment of the present disclosure. Algorithm 400 can be implemented in hardware or a suitable combination of hardware and software.

Algorithm 400 begins at 402, where radar speed data is generated, such as for a patrol car. In one example embodiment, the patrol car speed data can be determined from reflected signals from stationary objects or in other suitable manners. The algorithm then proceeds to 404.

At 404, the radar data is transmitted to an interface. In one example embodiment, the interface can have no functional interaction with the radar unit, such as when the interface is only configured to receive speed data from the radar unit. In another example embodiment, the interface can continuously generate a signal that blocks a reset function, such that the radar unit does not reset as long as the signal is being generated. The algorithm then proceeds to 406.

At 406, GPS speed data is generated. In one example embodiment, the GPS speed data can be generated simultaneously with the radar unit, even though the GPS speed system and radar system can otherwise be operating independently. The algorithm then proceeds to 408.

At 408, the GPS speed data is transmitted to the interface. In one example embodiment, the interface can have no functional interaction with the GPS unit, such as when the interface is only configured to receive speed data from the GPS unit. The algorithm then proceeds to 410.

At 410, it is determined at the interface whether the radar speed data and the GPS speed data are different, such as whether the speed data difference is greater than a predetermined tolerance. If it is determined that the speed data is different, the algorithm proceeds to 412, otherwise the algorithm returns to 402.

At 412, the radar vehicle speed data is reset. In one example embodiment, a blocking signal that is generated by the interface can be interrupted long enough to cause the radar speed unit to re-acquire the patrol vehicle speed, or other suitable processes can also or alternatively be used. The algorithm then returns to 402.

In operation, algorithm 400 allows a radar unit to be calibrated without using a GPS signal as a patrol speed for detection of speeding vehicles. While algorithm 400 is shown as a flow chart, a person of skill in the art will recognize that object-oriented programming, state diagrams, ladder diagrams or other suitable programming paradigms can also or alternatively be used to implement algorithm 400.

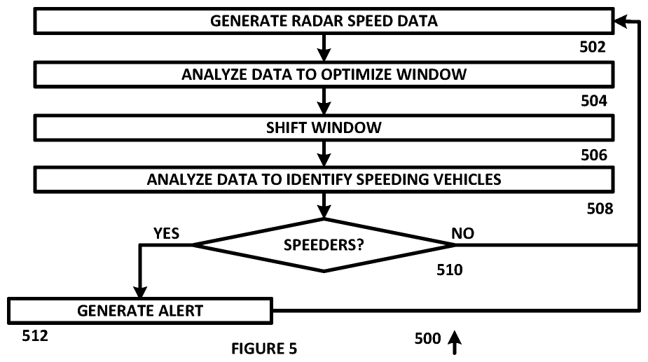

FIG. 5 is a diagram of an algorithm 500 for radar window adjustment, in accordance with an example embodiment of the present disclosure. Algorithm 500 can be implemented in hardware or a suitable combination of hardware and software.

Algorithm 500 begins at 502, where radar speed data is generated, such as by transmitting electromagnetic radiation and detecting reflected signals or in other suitable manners. The algorithm then proceeds to 504.

At 504, the radar data is analyzed to optimize a window for evaluation. In one example embodiment, the radar data can be analyzed to determine whether a target vehicle is approaching or receding from a patrol car. The algorithm then proceeds to 506.

At 506, the window for target vehicles is shifted. In one example embodiment, when a target vehicle is travelling faster than a patrol car, such as when the vehicle is approaching the patrol car from an opposite lane, the frequency data for the target vehicle can be to one side of the frequency bin for the patrol car speed, and when a target vehicle is traveling slower than the patrol speed, such as when a target vehicle is in the same lane, the frequency data for the target vehicle can be to the other side of the frequency bin for the patrol car speed. The algorithm then proceeds to 508.

At 508, the radar speed data is analyzed to identify speeding vehicles. In one example embodiment, the radar speed data can be offset, such that the patrol vehicle speed is not in the center of the radar data frequency window. The algorithm then proceeds to 510.

At 510, it is determined whether any speeders have been identified. If it is determined that there are speeders, the algorithm proceeds to 512, otherwise the algorithm returns to 502.

At 512, an alert is generated. The algorithm then returns to 502.

In operation, algorithm 500 allows a radar unit to be optimized for detection of speeding vehicles. While algorithm 500 is shown as a flow chart, a person of skill in the art will recognize that object-oriented programming, state diagrams, ladder diagrams or other suitable programming paradigms can also or alternatively be used to implement algorithm 500.

As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

As used herein, “hardware” can include a combination of discrete components, an integrated circuit, an application-specific integrated circuit, a field programmable gate array, or other suitable hardware. As used herein, “software” can include one or more objects, agents, threads, lines of code, subroutines, separate software applications, two or more lines of code or other suitable software structures operating in two or more software applications, on one or more processors (where a processor includes one or more microcomputers or other suitable data processing units, memory devices, input-output devices, displays, data input devices such as a keyboard or a mouse, peripherals such as printers and speakers, associated drivers, control cards, power sources, network devices, docking station devices, or other suitable devices operating under control of software systems in conjunction with the processor or other devices), or other suitable software structures. In one exemplary embodiment, software can include one or more lines of code or other suitable software structures operating in a general purpose software application, such as an operating system, and one or more lines of code or other suitable software structures operating in a specific purpose software application. As used herein, the term “couple” and its cognate terms, such as “couples” and “coupled,” can include a physical connection (such as a copper conductor), a virtual connection (such as through randomly assigned memory locations of a data memory device), a logical connection (such as through logical gates of a semiconducting device), other suitable connections, or a suitable combination of such connections. The term “data” can refer to a suitable structure for using, conveying or storing data, such as a data field, a data buffer, a data message having the data value and sender/receiver address data, a control message having the data value and one or more operators that cause the receiving system or component to perform a function using the data, or other suitable hardware or software components for the electronic processing of data.

In general, a software system is a system that operates on a processor to perform predetermined functions in response to predetermined data fields. A software system is typically created as an algorithmic source code by a human programmer, and the source code algorithm is then compiled into a machine language algorithm with the source code algorithm functions, and linked to the specific input/output devices, dynamic link libraries and other specific hardware and software components of a processor, which converts the processor from a general purpose processor into a specific purpose processor. This well-known process for implementing an algorithm using a processor should require no explanation for one of even rudimentary skill in the art. For example, a system can be defined by the function it performs and the data fields that it performs the function on. As used herein, a NAME system, where NAME is typically the name of the general function that is performed by the system, refers to a software system that is configured to operate on a processor and to perform the disclosed function on the disclosed data fields. A system can receive one or more data inputs, such as data fields, user-entered data, control data in response to a user prompt or other suitable data, and can determine an action to take based on an algorithm, such as to proceed to a next algorithmic step if data is received, to repeat a prompt if data is not received, to perform a mathematical operation on two data fields, to sort or display data fields or to perform other suitable well-known algorithmic functions. Unless a specific algorithm is disclosed, then any suitable algorithm that would be known to one of skill in the art for performing the function using the associated data fields is contemplated as falling within the scope of the disclosure. For example, a message system that generates a message that includes a sender address field, a recipient address field and a message field would encompass software operating on a processor that can obtain the sender address field, recipient address field and message field from a suitable system or device of the processor, such as a buffer device or buffer system, can assemble the sender address field, recipient address field and message field into a suitable electronic message format (such as an electronic mail message, a TCP/IP message or any other suitable message format that has a sender address field, a recipient address field and message field), and can transmit the electronic message using electronic messaging systems and devices of the processor over a communications medium, such as a network. One of ordinary skill in the art would be able to provide the specific coding for a specific application based on the foregoing disclosure, which is intended to set forth exemplary embodiments of the present disclosure, and not to provide a tutorial for someone having less than ordinary skill in the art, such as someone who is unfamiliar with programming or processors in a suitable programming language. A specific algorithm for performing a function can be provided in a flow chart form or in other suitable formats, where the data fields and associated functions can be set forth in an exemplary order of operations, where the order can be rearranged as suitable and is not intended to be limiting unless explicitly stated to be limiting.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

What is claimed is:

1. A method for calibrating a patrol vehicle speed, comprising:
initiating a calibration cycle at a speed detection radar unit mounted in a vehicle;
operating the vehicle to generate a vehicle speed signal using the speed detection radar unit; and
exiting the calibration cycle if the vehicle speed signal matches an observed speed from an independent source signal.

2. The method of claim 1 wherein initiating the calibration cycle comprises automatically initiating the calibration cycle.

3. The method of claim 1 wherein initiating the calibration cycle comprises manually initiating the calibration cycle.

4. The method of claim 1 wherein operating the vehicle to generate the vehicle speed signal using the speed detection radar unit comprises driving the vehicle for a predetermined period of time.

5. The method of claim 1 wherein operating the vehicle to generate the vehicle speed signal using the speed detection radar unit comprises driving the vehicle for a predetermined period of time on a non-linear course.

6. The method of claim 1 wherein exiting the calibration cycle if the vehicle speed signal matches the observed speed from the independent source signal comprises automatically determining whether the vehicle speed signal matches the observed speed from the independent source signal.

7. The method of claim 1 wherein exiting the calibration cycle if the vehicle speed signal matches the observed speed from the independent source signal comprises performing a comparison of the vehicle speed signal and the observed speed at an interface unit.

8. The method of claim 1 wherein exiting the calibration cycle if the vehicle speed signal matches the observed speed from the independent source signal comprises performing a comparison of the vehicle speed signal and the observed speed at an interface unit between the speed detection radar unit and the independent signal source.

9. A system for determining a vehicle speed, comprising:
a speed detection module configured to generate speed data from an independent source signal;
a radar speed detection module configured to generate speed data from a reflected signal source; and
an interface module configured to receive the speed data from the speed detection module and the speed data from the radar speed detection module and to interrupt a blocking signal if a difference between the speed data from the speed detection module and the speed data from the radar speed detection module is greater than a predetermined tolerance.

10. The system of claim 9 wherein the independent source signal is generated by a satellite in earth orbit.

11. The system of claim 9 wherein the independent source signal is generated by a terrestrial system.

12. The system of claim 9 wherein the interface module comprises a digital signal processor.

13. The system of claim 9 wherein the interface module comprises a digital signal processor operating in the speed detection module.

14. The system of claim 9 wherein the interface module comprises a digital signal processor operating in the radar speed detection module.

15. The system of claim 9 wherein the blocking signal is continuously generated during stationary and mobile operation.

16. The system of claim 9 wherein the radar speed detection module is configured to re-acquire the speed data when the blocking signal is interrupted.

17. A system for determining a vehicle speed, comprising:
a speed detection module configured to generate speed data from an independent source signal;
a radar speed detection module configured to generate speed data from a reflected signal source; and
the radar speed detection module configured to process the speed data to generate first speed data associated with a vehicle that the speed detection module is deployed on and second speed data associated with a target vehicle by using a window that is offset from the speed data from the independent source signal.

18. The system of claim 17 wherein the window is a frequency domain window.

19. The system of claim 17 wherein the window is a frequency domain window and the speed data from the independent source signal is a frequency that is not centered in the frequency domain window.

20. The system of claim 17 wherein the window is a frequency domain window and the speed data from the independent source signal is a frequency that is offset by a predetermined frequency in the frequency domain window.
